(19) United States
(12) Patent Application Publication
(10) Pub. No.: US 2026/0118607 A1
(43) Pub. Date: Apr. 30, 2026

(54) OPTICAL-ELECTRICAL INTEGRATED DEVICE

(71) Applicant: SHINKO ELECTRIC INDUSTRIES CO., LTD., Nagano (JP)

(72) Inventors: Tomoharu FUJII, Nagano (JP); Yuji FURUTA, Nagano (JP); Hisashi KANEDA, Nagano (JP)

(21) Appl. No.: 19/365,859

(22) Filed: Oct. 22, 2025

(30) Foreign Application Priority Data
Oct. 30, 2024 (JP) 2024-190647

(51) Int. Cl. G02B 6/42

(52) U.S. Cl. CPC G02B 6/424; G02B 6/4212; G02B 6/4239; G02B 6/4245

(57) ABSTRACT

An optical-electrical integrated device includes a wiring board having a glass layer, and an interconnect layer disposed on the glass layer and including a pad, a photonic integrated circuit disposed on the glass layer and electrically connected to the pad, an optical fiber disposed on the glass layer and configured to transmit and receive an optical signal to and from the photonic integrated circuit, and a fixing member made of glass, disposed on the glass layer, and configured to clamp the optical fiber between the glass layer and the fixing member.

### CROSS-REFERENCE TO RELATED APPLICATIONS

This application is based upon and claims priority to Japanese Patent Application No. 2024-190647, filed on October 30, 2024, the entire contents of which are incorporated herein by reference.

### FIELD

Certain aspects of the embodiments discussed herein are related to optical-electrical integrated devices. The optical-electrical integrated devices are sometimes also referred to as optoelectronic hybrid modules.

### BACKGROUND

In a data center or the like where various computers and devices for data communication or the like are installed, an optical coupling structure for connecting an optical waveguide device and an optical fiber or the like may be used. An example of such an optical coupling structure includes an optical coupling component using a planar lightwave circuit that is bonded and fixed to end surfaces of input/output waveguides of the optical waveguide device, and the optical waveguide device and the optical fiber are optically coupled via the planar lightwave circuit, as proposed in Japanese Laid-Open Patent Publication No. 2020-64211, for example.

In the optical coupling structure described above, the optical waveguide device and the optical coupling component are bonded and fixed to each other via a small bonding area, and thus, a bonding or adhesive strength between the optical waveguide device and the optical coupling component is weak. For this reason, when stress is applied to a coupling part between the optical waveguide device and the optical coupling component, a fracture may occur between the optical waveguide device and the optical coupling component, and a reliability of the optical coupling may deteriorate.

### SUMMARY

Accordingly, it is an object in one aspect of the embodiments to provide an optical-electrical integrated device having an optical coupling structure with a high reliability of optical coupling.

According to one aspect of the embodiments, an optical-electrical integrated device includes a wiring board having a glass layer, and an interconnect layer disposed on the glass layer and including a pad; a photonic integrated circuit disposed on the glass layer and electrically connected to the pad; an optical fiber disposed on the glass layer and configured to transmit and receive an optical signal to and from the photonic integrated circuit; and a fixing member made of glass, disposed on the glass layer, and configured to clamp the optical fiber between the glass layer and the fixing member.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a plan view illustrating an example of an optical-electrical integrated device according to a first embodiment;

FIG. 2 is a cross sectional view (part 1) illustrating the example of the optical-electrical integrated device according to the first embodiment;

FIG. 3 is a cross sectional view (part 2) illustrating example of the optical-electrical integrated device according to the first embodiment;

FIG. 4 is a plan view illustrating an example of the optical-electrical integrated device according to a first modification of the first embodiment; and

FIG. 5 is a cross sectional view illustrating the example of the optical-electrical integrated device according to a first modification of the first embodiment.

### DESCRIPTION OF EMBODIMENTS

Hereinafter, embodiments of the present disclosure will be described with reference to the accompanying drawings. In the drawings, the same constituent elements or components are designated by the same reference numerals, and a redundant description thereof may be omitted.

### First Embodiment

### Structure of Optical-Electrical Integrated Device

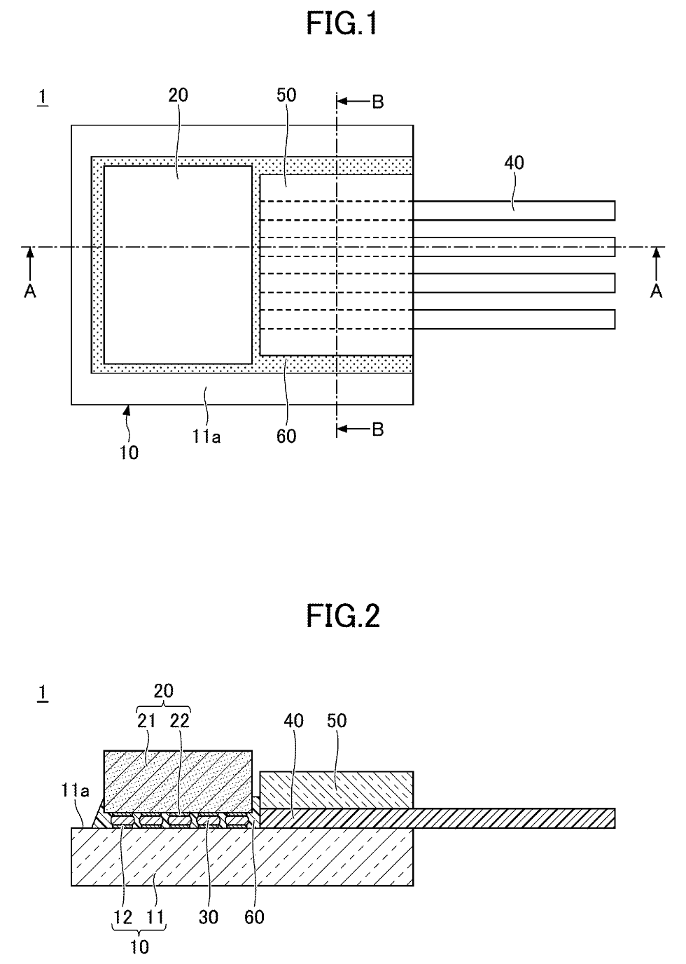

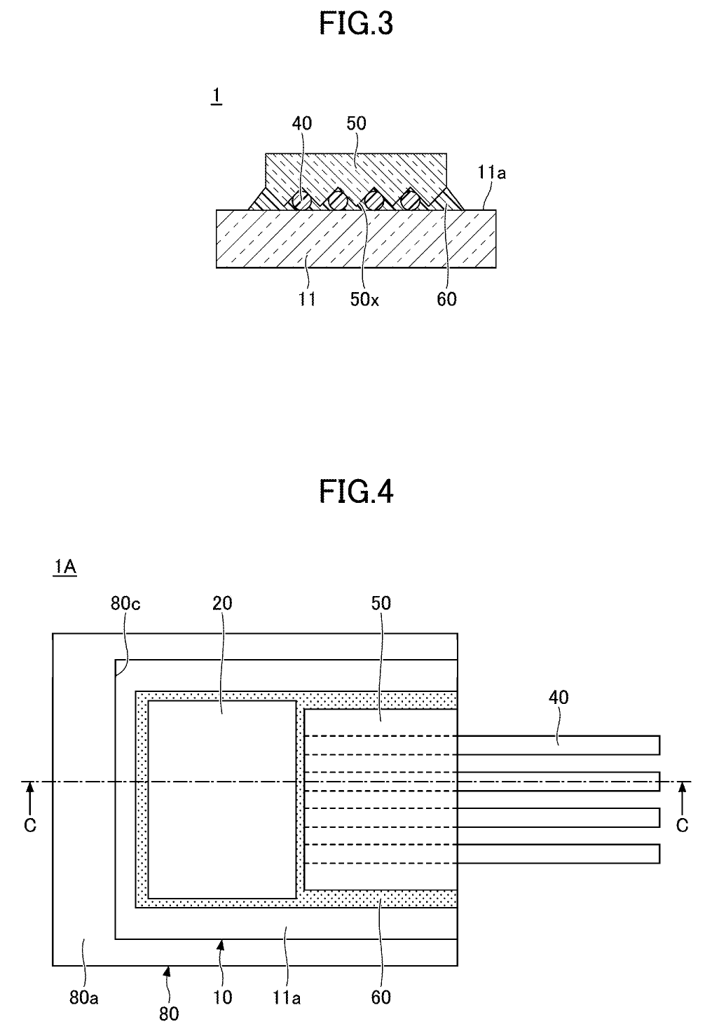

FIG. 1 is a plan view illustrating an example of an optical-electrical integrated device according to a first embodiment. FIG. 2 is a cross sectional view illustrating the example of the optical-electrical integrated device according to the first embodiment, and illustrates a cross section taken along a line A-A in FIG. 1. FIG. 3 is a cross sectional view illustrating the example of the optical-electrical integrated device according to the first embodiment, and illustrates a cross section taken along a line B-B in FIG. 1.

As illustrated in FIG. 1, FIG. 2, and FIG. 3, an optical-electrical integrated device 1 includes a wiring board 10, a photonic integrated circuit (PIC) 20, an optical fiber 40, and a fixing member 50. The optical-electrical integrated device 1 may further include a bonding material 30 and a resin part 60.

The wiring board 10 has a glass layer 11 and an interconnect layer 12. The wiring board 10 may have one or more electronic components electrically connected to the interconnect layer 12. The electronic components include passive components and active components. Examples of the active components include semiconductor devices having a function of amplifying an electrical signal input from the photonic integrated circuit 20, for example.

The glass layer 11 is an insulating layer. The type of glass constituting the glass layer 11 is not particularly limited, and for example, alkali-free glass, quartz glass, borosilicate glass, or the like can be used for the glass layer 11. A thickness of the glass layer 11 is approximately 100 μm to approximately 1000 μm, for example.

The interconnect layer 12 is provided on an upper surface 11a of the glass layer 11. The interconnect layer 12 may be provided so that a lower surface and a side surface of the interconnect layer 12 are embedded in the glass layer 11 and an upper surface of the interconnect layer 12 is exposed from the upper surface 11a of the glass layer 11. The interconnect layer 12 includes pads and one or more interconnect patterns. A material used for the interconnect layer 12 may be copper (Cu) or the like, for example. A thickness of the interconnect layer 12 is approximately 10 μm to approximately 40 μm, for example.

If required, a metal layer may be formed on upper surfaces of the pads constituting the interconnect layer 12, or an anti-oxidation treatment, such as an organic solderability preservative (OSP) treatment or the like, may be performed on the upper surfaces of the pads constituting the interconnect layer 12. Examples of the metal layer include a gold (Au) layer, a nickel/gold (Ni/Au) layer (a metal layer in which a Ni layer and a Au layer are stacked in this order), a nickel/palladium/gold (Ni/Pd/Au) layer (a metal layer in which a Ni layer, a Pd layer, and a Au layer are stacked in this order), or the like.

The glass layer 11 may be provided with a through hole penetrating the glass layer 11 in a thickness direction of the glass layer 11. In addition, an interconnect layer may be provided on a lower surface of the glass layer 11. The interconnect layer provided on the lower surface of the glass layer 11 may be connected to the interconnect layer 12 via the through hole penetrating the glass layer 11.

The photonic integrated circuit 20 includes a main body 21 and electrodes 22. The main body 21 is a substrate made of silicon or the like and having a plurality of optical waveguides, light emitting elements, light receiving elements, or the like provided on the substrate, for example. The electrodes 22 are connection terminals formed of gold bumps, solder bumps, copper posts with solder provided on tip ends thereof, or the like, for example. The electrodes 22 are disposed on one surface of the main body 21. The optical waveguides and the electrodes 22 are disposed on the same surface side of the main body 21.

The photonic integrated circuit 20 may be referred to as silicon photonics or the like. The photonic integrated circuit 20 can have a function of converting an optical signal input from the optical fiber 40 into an electrical signal and/or a function of converting an input electrical signal into an optical signal and outputting the optical signal to the optical fiber 40.

The photonic integrated circuit 20 is disposed on the glass layer 11, and is electrically connected to the pads constituting the interconnect layer 12. Specifically, the photonic integrated circuit 20 is flip-chip mounted face-down on the upper surface 11a of the glass layer 11. That is, the electrodes 22 of the photonic integrated circuit 20 are bonded to the pads constituting the interconnect layer 12 via the conductive bonding material 30, such as solder or the like.

The optical fiber 40 is disposed on the glass layer 11 adjacent to the photonic integrated circuit 20. The number of the optical fibers 40 provided may be an arbitrary number that is one or more. In the illustrated example, four optical fibers 40 are arranged in parallel at predetermined intervals. The optical fibers 40 extend to the outside of the glass layer 11 across one side of the upper surface 11a of the glass layer 11 in the plan view.

A gap between each optical fiber 40 and the photonic integrated circuit 20 is approximately several tens of micrometers, for example. An end of each optical waveguide of the photonic integrated circuit 20 faces an end of each optical fiber 40. For this reason, each optical waveguide of the photonic integrated circuit 20 can transmit and receive an optical signal to and from each optical fiber 40. A bonding material may be disposed in the gap between each optical fiber 40 and the photonic integrated circuit 20. For example, an optical adhesive having a good transmittance with respect to wavelengths of the optical signal transmitted and received between the optical fibers 40 and the photonic integrated circuit 20 can be used for the bonding material disposed in the gap between each optical fiber 40 and the photonic integrated circuit 20.

The fixing member 50 is disposed on the glass layer 11, and clamps (or holds) the optical fibers 40 between the glass layer 11 and the fixing member 50. The fixing member 50 is made of glass, for example. The fixing member 50 has grooves 50x having an elongated shape in a surface of the fixing member 50 facing the upper surface 11a of the glass layer 11. For example, the grooves 50x have a V shape in a cross section cut perpendicularly to a longitudinal direction of the grooves 50x. The cross section of the grooves 50x cut perpendicularly to the longitudinal direction of the grooves 50x may have a shape other than the V shape, such as a U shape or the like.

The optical fibers 40 are in contact with the upper surface 11a of the glass layer 11 and inner walls of the grooves 50x. Thus, the optical fibers 40 are held between the glass layer 11 and the fixing member 50. The fixing member 50 is preferably made of the same glass material as the glass layer 11. Accordingly, coefficients of thermal expansion of the members located above and below the optical fibers 40 are the same, and thus, it is possible to prevent positions of the optical fibers 40 from varying depending on a change in a temperature environment. As a result, it is possible to stably transmit and receive optical signals between the optical fibers 40 and the photonic integrated circuit 20.

The resin part 60 is located on the upper surface 11a of the glass layer 11. The resin part 60 is located at least around the bonding material 30 between the photonic integrated circuit 20 and the upper surface 11a of the glass layer 11, and around the optical fibers 40 between the inner walls of the grooves 50x and the upper surface 11a of the glass layer 11. Accordingly, it is possible to improve a reliability of optical coupling between the photonic integrated circuit 20 and the glass layer 11, and bond the fixing member 50 to the glass layer 11. A material having good flowability is preferably used for the resin part 60 because the material needs to flow into a narrow space. The material used for the resin part 60 may be an insulating resin, such as an epoxy-based resin or the like, for example.

As described above, in the optical-electrical integrated device 1, an interface (or optical coupling section) between the photonic integrated circuit 20 and the optical fibers 40 is located on the glass layer 11. In addition, the optical fibers 40 are clamped between the glass layer 11 and the fixing member 50. Accordingly, unlike a structure in which an interface between two members is located outside a substrate in the plan view as in the related art, stress is less likely to concentrate at the interface between the photonic integrated circuit 20 and the optical fibers 40 in the present embodiment. For this reason, it is possible to reduce a risk of a fracture occurring at the interface between the photonic integrated circuit 20 and the optical fibers 40. That is, an optical coupling structure having a high reliability of optical coupling can be provided between the photonic integrated circuit 20 and the optical fibers 40.

Further, because the optical-electrical integrated device 1 includes the resin part 60, it is possible to increase a strength of the interface between the photonic integrated circuit 20 and the optical fibers 40.

### First Modification of First Embodiment

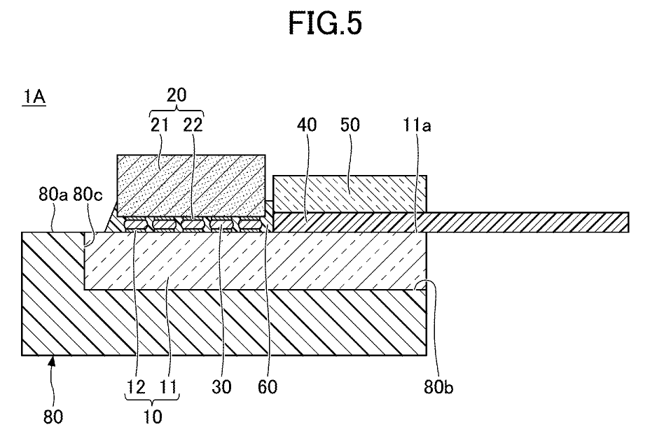

In a first modification of the first embodiment, an example of the optical-electrical integrated device including a resin substrate will be described. FIG. 4 is a plan view illustrating an example of the optical-electrical integrated device according to the first modification of the first embodiment. FIG. 5 is a cross sectional view illustrating the example of the optical-electrical integrated device according to the first modification of the first embodiment, and illustrates a cross section taken along a line C-C in FIG. 4. As illustrated in FIG. 4 and FIG. 5, an optical-electrical integrated device 1A differs from the optical-electrical integrated device 1 in that the optical-electrical integrated device 1A includes a resin substrate 80.

The resin substrate 80 is formed of an insulating resin material, such as an epoxy-based resin or the like, for example. The resin substrate 80 may include a reinforcing member, such as a glass cloth or the like. The resin substrate 80 may be a build-up substrate in which one or more insulating layers and one or more interconnect layers are stacked. The resin substrate 80 includes an upper surface 80a, a stepped surface 80b that is recessed from the upper surface 80a, and an inner surface 80c that connects the upper surface 80a and the stepped surface 80b. The upper surface 80a and the stepped surface 80b can be parallel to each other, for example. The stepped surface 80b and the inner surface 80c may be perpendicular to each other, for example.

The glass layer 11 is disposed on the stepped surface 80b with the interconnect layer 12 facing the side opposite to the stepped surface 80b. By disposing the glass layer 11 on the stepped surface 80b that is recessed from the upper surface 80a, and a height of the optical-electrical integrated device 1A can be reduced. The resin substrate 80 may include one or more electronic components. Examples of the electronic component include passive components and active components. For example, a semiconductor device may be mounted on the resin substrate 80, and the semiconductor device and the photonic integrated circuit 20 may be electrically connected via an interconnect layer provided on the resin substrate 80 and a through hole provided in the glass layer 11.

In the plan view, the optical fibers 40 extend to the outside of the resin substrate 80 across one side of the resin substrate 80. The upper surface 80a of the resin substrate 80 and the upper surface 11a of the glass layer 11 may coincide, for example. In this case, it is possible to continuously form the interconnect layer on the upper surface 80a of the resin substrate 80 and on the upper surface 11a of the glass layer 11.

In the plan view, an entirety of the upper surface 11a of the glass layer 11 preferably overlaps the resin substrate 80. In other words, a side surface of the glass layer 11 preferably does not protrude from a side surface of the resin substrate 80. In this case, it is possible to prevent the end of the glass layer 11 from cracking and chipping. The side surface of the glass layer 11 may coincide with the side surface of the resin substrate 80, or may be located at a position recessed inward from the side surface of the resin substrate 80.

The stepped surface 80b can be formed by performing a recess machining on the resin substrate 80 that does not have the stepped surface 80b, for example. The stepped surface 80b may be formed by stacking a plurality of resin layers. For example, a lower, first resin layer may be provided, and a second resin layer that has an opening exposing a portion of an upper surface of the first resin layer can be stacked on the upper surface of the first resin layer. In this case, the upper surface of the first resin layer exposed via the opening of the second resin layer serves as the stepped surface 80b.

In the example of the optical-electrical integrated device 1A, the glass layer 11 has a rectangular shape in the plan view, and the resin substrate 80 is provided such that three side surfaces of the glass layer 11 are in contact with the inner surface 80c in the plan view. However, the present invention is not limited to such an arrangement, and the resin substrate 80 may be provided so that all of the four side surfaces of the glass layer 11 are in contact with the inner surface 80c, for example. In this case, the glass layer 11 is surrounded by the resin substrate 80 in a picture-frame shape in the plan view, and thus, all of the side surfaces of the glass layer 11 can be protected by the resin substrate 80.

According to the present disclosure, it is possible to provide an optical-electrical integrated device having an optical coupling structure with a high reliability of optical coupling.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical-electrical integrated device comprising:
a wiring board having a glass layer, and an interconnect layer disposed on the glass layer and including a pad;
a photonic integrated circuit disposed on the glass layer and electrically connected to the pad;
an optical fiber disposed on the glass layer and configured to transmit and receive an optical signal to and from the photonic integrated circuit; and
a fixing member made of glass, disposed on the glass layer, and configured to clamp the optical fiber between the glass layer and the fixing member.

2. The optical-electrical integrated device as claimed in claim 1, wherein:
the fixing member has a surface facing an upper surface of the glass layer, and a groove formed in the surface of the fixing member, and
the optical fiber is in contact with the upper surface of the glass layer and an inner wall of the groove.

3. The optical-electrical integrated device as claimed in claim 2, further comprising:
a resin part located on the upper surface of the glass layer, wherein:
the photonic integrated circuit is bonded to the pad via a conductive bonding material, and
the resin part is located at least around the bonding material between the photonic integrated circuit and the upper surface of the glass layer, and around the optical fiber between the inner wall of the groove and the upper surface of the glass layer.

4. The optical-electrical integrated device as claimed in claim 1, wherein the optical fiber extends to an outside of the glass layer across one side of the upper surface of the glass layer in a plan view.

5. The optical-electrical integrated device as claimed in claim 1, wherein the fixing member and the glass layer are formed of identical glass materials.

6. The optical-electrical integrated device as claimed in claim 1, further comprising:
a resin substrate having an upper surface and a stepped surface recessed from the upper surface of the resin substrate, wherein:
the glass layer is disposed on the stepped surface with the interconnect layer facing a side opposite to the stepped surface, and
the optical fiber extends to an outside of the resin substrate across one side of the resin substrate in a plan view.

7. The optical-electrical integrated device as claimed in claim 6, wherein the upper surface of the resin substrate and the upper surface of the glass layer coincide.

8. The optical-electrical integrated device as claimed in claim 6, wherein an entirety of the upper surface of the glass layer overlaps the resin substrate in the plan view.
